(19) United States
(12) Patent Application Publication
(10) Pub. No.: US 2007/0072440 A1
(43) Pub. Date: Mar. 29, 2007

(54) Composite collectors

(76) Inventors: Christopher John Spacie, South Wales (GB); Anthony Berian Davies, South Wales (GB); Robin Stuart Hopker, South Wales (GB); James Charles Boff, London (GB)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 10/595,750

(22) PCT Filed: Nov. 10, 2004
(86) PCT No.: PCT/GB04/04737

§ 371 Date: May 9, 2006

(30) Foreign Application Priority Data
Nov. 11, 2003 (GB) 0326271.4

(51) Int. Cl. H01R 39/00

(52) U.S. Cl. 439/1

(57) ABSTRACT

A composite electrical collector comprises a metal mesh embedded in a tribologically acceptable matrix.

This invention relates to composite collectors for electrical apparatus. The invention also relates to methods of making such collectors.

Collectors are used to transfer electricity to or from a conductor and to make sliding contact with the conductor.

Electrified railway vehicles derive power from an overhead contact wire system (commonly known as an overhead contact line or OCL) or a powered rail. In both case the collector is in sliding contact with the conductor. With the overhead system, typically a pantograph mechanism placed on the roof of the vehicle comprises a current collector that transfers current from the overhead wire to drive the vehicle. [An alternative arrangement is used for some trolley buses, which use a collector on a trolley pole. The present invention encompasses such arrangements and is intended to cover all systems in which a vehicle draws current from a conductor]. While this arrangement has been generally satisfactory, over the years the operational speed of railway vehicles has increased and the margins of acceptable current collection have been reduced. With such increasing demands, there is a need for improved materials capable of operating in this demanding environment.

In the past collector materials have traditionally fallen into three categories:—
Extruded—A soft mouldable carbon is produced by the mixing of coke and graphite with a tar or pitch binder. This material can be extruded through dies and a wide variety of cross sections obtained. After extrusion kilning is performed resulting in strong porous carbon.
Metallised—The porous nature of the extruded carbon can be utilised to perform metallisation. Molten metal is forced under pressure into the pores of the material. This increases mechanical strength and electrical and thermal conductivity. One example of a metallised collector can be found in U.S. Pat. No. 5,657,842, in which a carbon-fibre-reinforced carbon material comprises pins, fibres, foils, or strips of electrically conductive materials (e.g. metal). A further example is WO01/08920 in which a three-dimensionally extending carbon fibre web forms part of a carbon-carbon composite which may be impregnated with metal. The metal impregnation process is labour intensive and thus costly.
Sintered—These are produced by mixing metals and graphite powders that are then pressed to shape and heat treated. Electrical and thermal conductivity is excellent but mechanical strength is generally lower than in extruded or metallised grades. Greater weight is also a potential disadvantage.

Recently proposed (CN1178745, CN1265429, and CN1468891) for use in collectors have been hot pressed materials comprising copper powder/fibres or copper coated powders, carbon fibre, and resin.

The applicants have realised that a drawback of existing collectors is that their resistivity is determined by the resistivity of the carbon, or for metallised or sintered materials, by the metal content and connectivity of the metal. It would be preferable to have a continuous metal conductor mounted in a tribologically acceptable matrix (e.g. carbon).

By providing a metal mesh embedded in a tribologically acceptable matrix the resultant material will have a low resistivity (due to the continuous electrical path supplied by the metal mesh) and high flexural strength (due to the composite nature of the material).

Additionally the complexity of a metal impregnation step is avoided.

Accordingly the present invention provides a composite electrical collector, for use in transferring electricity to or from a conductor and to make sliding contact with the conductor, the collector comprising a metal mesh embedded in a tribologically acceptable matrix.

The tribologically acceptable matrix may be a carbon based material.

Such a collector can provide a continuous current path through the mesh from the conductor to the remote side of the collector, hence the system resistance will be low.

Further features of the invention are as set out in the claims as exemplified in the following description in which:—

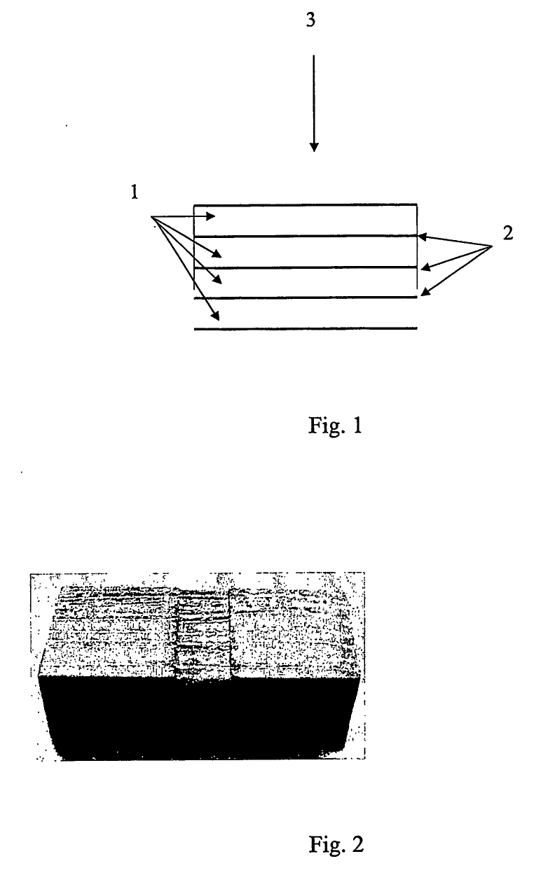

FIG. 1 shows a method of forming a collector according to the invention

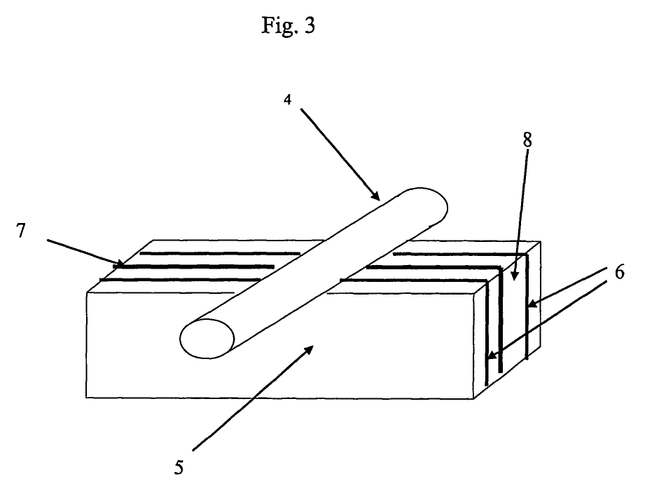

FIG. 2 is a photograph of a product made to the method of FIG. 1; and

FIG. 3 shows figuratively a collector and associated conductor.

Composite collectors according to the invention can be made by providing layers of a metal mesh and a tribologically suitable material, and pressing the layers to permit the tribologically suitable material to merge through apertures in the mesh and thereby form the composite body.

For example, as shown in FIG. 1, a collector can be formed, under pressure and heat, from a composite material of alternative layers consisting of:—

a) coke, graphite and a phenolic novolak resin; and

b) an expanded copper mesh.

The coke/graphite/resin layers 1, and copper mesh layers 2 are interleaved and pressed in pressing direction 3.

The result is a layered composite material and FIG. 2 shows this.

### EXAMPLE

1. The coke/graphite/resin mix is prepared in the following manner
2. A pre-mix is prepared by blending the following components in a low-energy mixer, such as a ‘Z’ blade mixer, at ambient temperature.
   Petroleum Coke—Grade Z11C(K) from James Durrans & Sons ˜50% Ltd, Sheffield, England
   Foundry Coke—Grade NH358(N) manufactured at Morganite ˜31% Electrical Carbon Limited, Swansea, Wales
   Lamp Black—Grade Z35 from Laporte Pigments Brockhues AG, ˜15% Walluf, Germany
   Graphite—Grade Hart 80 from David Hart Ltd., Alcester, England ˜5%
3. This material is then mixed in a high-energy Intermixer™ at 70-80° C. with the following components:—
   Pre-mix 1 ˜77%
   Phenolic resin—Grade PR82 from Borden Chemicals Ltd., Sully, ˜19% Wales
   Hexamine—from VWR International, Poole, England 2.0%
   Nylon fibres—from Alpha Electrostatic Flocking Ltd., Kenfig, 2.0% Wales
4. This material is crushed to a fine powder and mixed with propan-2-ol (100 g solids to 25 ml solvent) to form a paste (Component 1).
   Whilst the composition of component 1 is predominantly carbon based, because the metallic mesh provides the electrical conduction path, the interlayer material may be an insulator e.g. ceramic materials or a carbon/ceramic mix with the appropriate tribological properties. Other suitable interlayer materials include high temperature thermoplastics loaded with appropriate fillers.
   The interlayer material may also comprise:—
      fibres to provide additional strength (the fibres if conducting may also or alternatively provide improved electrical conductivity—e.g. carbon fibres, carbon nanofibres);
      thermally conductive materials to assist heat transfer and dissipation;
      electrically conductive fillers in powder, fibre, or plate form to assist in electrical conductivity and to reduce the risk of hot spots;
      if the intended use of the collector permits, minor abrasive materials to promote electrical contact with the conductor
      lubricants
      antioxidants to reduce degradation of the conductor contacting surface of the collector.
   The materials of CN1178745, CN1265429, and CN1468891 or like materials may be used as the interlayer material.
5. The paste is then placed onto a surface and rolled flat. An expanded copper mesh such as Expamet Grade 947 [from The Expanded Metal Company, Hartlepool, England] (Component 2) is then placed onto the sheet and a further layer of paste applied and spread over the copper. This is then rolled into a sheet approximately 1-2 mm thick. While an expanded copper mesh is exemplified, other mesh forms such as woven or knitted meshes or non-woven felt-like meshes can be used. Advantageously the electrical connectivity of the mesh should be high and so expanded metal mesh is preferred to woven or knitted mesh, and both are preferred to felt-like meshes.
6. The sheets are left to dry at 50° C.
7. The sheets are then cut to appropriate size.
8. The cut sheets are then stacked upon each other (the number depending on the thickness of the block required) and the required shape is pre-formed by pressing in a die at ambient temperature at 1-2 tonnes/in² (˜15-50 MPa).
9. This pre-form is then hot pressed at 160° C. at 2-5 tonnes/in² (30-75 MPa) for 5 minutes to form a solid block.
10. The block is then further cured by heating at 10° C./hour to 180° C. It is held at this temperature for a further 2 hours.
11. The block is kilned by heating at 50° C./hour to 800° C. in an inert atmosphere, for example of 98% nitrogen and 2% hydrogen. It is held at this temperature for a further 2 hours.

[The curing an kilning steps of course depend upon the nature of the material used as an interlayer and kilning may not be necessary. The exact conditions disclosed above solely refer to the specific example given].

Typical properties of this material are:—
Density 1.90 gcmM⁻³.
Resistivity <1 μΩ.m (in the direction of the copper mesh).

Fabrication need not involve hot pressing, any route that enables a laminated structure to be prepared e.g. rolling can be utilised. For example, the process of extruding sheet materials described in W002/090291 lends itself to the rolling-in of mesh materials into a graphite or carbon sheet.

### Example 2

A premix of 37 parts natural graphite to 15 parts phenolic resin was prepared by wet blending the ingredients, drying at 60° C., and milling. An interlayer material was made by dry blending the ingredients (in wt %):—

| | |
|---|---|
| Premix | 42% |
| Electrolytic copper powder | 43% |
| Powdered phenolic resin | 10% |
| 6 mm length epoxy coated PAN carbon | 5% |
| fibres | |

The resultant mixture was then pressed about a copper mesh to form a preform and hot pressed to form a block as in the previous example.

The resultant product showed a density of 2.47 g.cm⁻³ and a low electrical resistivity.

The invention can also accommodate the inclusion of non-metallic web layers (e.g. carbon fibre meshes or cloths) in addition to the metal mesh, to provide additional strength.

After forming the laminated structure, the structure may be impregnated with resin or other materials to improve characteristics (e.g. strength, tribological properties etc.)

Prepared materials have been mounted and tested on a dynamic pantograph test rig and have been shown to give comparable wear results to field trials i.e. ˜10 mm/10000 km.

The material may be mounted in any conventional manner and may if desired be sheathed to protect against delamination or other damage.

FIG. 3 shows an example of a collector 5 for drawing current from a conductor 4. The Collector 5 comprises metallic mesh conductors 6 and a strengthening web 7 (e.g. a carbon cloth or fibrous web) embedded in a tribologically acceptable matrix 8.

The distribution of the meshes within the collector, and indeed the distribution of strengthening webs, need not be uniform. Additional strength may be provided in those parts of the collector (e.g leading and perhaps trailing edges) where greatest impact occurs, by locating strengthening webs in those regions. The density of meshes may be maximised in those regions of the current collector where greatest contact with the conductor occurs to maximise current collection.

The metallic mesh will be oriented so that it has edge contact with the conductor, as shown in FIG. 3. When there is a plurality of metal meshes each may contact the conductor. The meshes need not be strictly perpendicular to the conductor contacting face of the collector and may be oriented at an angle so that, for example, the meshes lean into, or lean back from the predominant direction of travel of the collector.

1. A composite electrical collector, for use in transferring electricity to or from a conductor and to make sliding contact with the conductor, the collector comprising a metal mesh embedded in a tribologically acceptable matrix selected from the group consisting of:—
non metal-impregnated carbon materials,
coke/graphite/resin composites,
ceramic materials,
carbon/ceramic mixes and
high temperature thermoplastics loaded with appropriate fillers.

2. A composite electrical collector as claimed in claim 1, in which the tribologically acceptable matrix additionally comprises one or more additives selected from the group consisting of:—
strengthening and/or electrically conductivity improving fibres;
thermally conductive materials;
electrically conductive fillers;
abrasive materials;
lubricants and
antioxidants.

3. A composite electrical collector as claimed in claim 1, in which the carbon based material is a coke/graphite/resin mix.

4. A composite electrical collector as claimed in claim 1, in which the metal mesh is a copper mesh.

5. A composite electrical collector as claimed in claim 1, in which the metal mesh embedded in a tribologically acceptable matrix consists of a pressed laminated body of coke/graphite/resin matrix material and metal mesh.

6. A composite electrical collector as claimed in claim 1, in which one or more non-metallic strengthening web layers are provided in addition to the metal mesh.

7. A composite electrical collector as claimed in claim 6, in which the non-metallic strengthening web layers are distributed non-uniformly within the body of the collector.

8. A composite electrical collector as claimed in claim 1, in which the metal mesh comprises a plurality of metal meshes embedded in the tribologically acceptable matrix.

9. A composite electrical collector as claimed in claim 8, in which the plurality of metal meshes are distributed non-uniformly within the body of the collector.

10. A composite electrical collector as claimed in claim 1, in which the metal mesh is disposed non-perpendicular to a conductor contacting face of the collector.

11. A method of making a composite electrical collector as claimed in claim 1 in which layers of matrix material and metal mesh are pressed together to form a laminated structure without a metal impregnation step.

12. A method, as claimed in claim 11, in which the laminated structure is raised to an elevated temperature after or during pressing.

13. A method, as claimed in claim 12, in which the laminated structure is kilned under an inert atmosphere.

14. A method, as claimed in claim 11, in which the laminated structure is resin impregnated after forming.

15. An electrically powered vehicle drawing current from a conductor by a collector as claimed in claim 1.
